(19) United States
(12) Patent Application Publication
(10) Pub. No.: US 2021/0233436 A1
(43) Pub. Date: Jul. 29, 2021

(54) UTILITY SERVICES MARKER

(71) Applicant: Barry Hardy, Livingston, LA (US)

(72) Inventor: Barry Hardy, Livingston, LA (US)

(21) Appl. No.: 17/154,005

(22) Filed: Jan. 21, 2021

Related U.S. Application Data
(60) Provisional application No. 62/967,511, filed on Jan. 29, 2020.

(51) Int. Cl. G09F 7/16; G09F 7/18

(52) U.S. Cl. CPC G09F 7/165; G09F 2007/1856; G09F 7/18

(57) ABSTRACT

This is a method and apparatus for use therein that provides a novel means to mark the location of a utility of a home or other building. The method comprises attaching a stencil marker to the form at the location of a utility before the slab is poured, pouring the slab and allowing it to cure, and then removing the form and stencil marker. In one or more embodiments, the stencil marker comprises a lightweight material capable of being folded without failure. The location of the fold is so that at least one indicator hangs down from the form and to the concrete.

### CROSS REFERENCE TO RELATED APPLICATIONS

This application claims priority to the Provisional U.S. patent application No. 62/967,511 entitled “Service Mark,” filed Jan. 29, 2020.

### STATEMENT REGARDING FEDERALLY SPONSORED RESEARCH OR DEVELOPMENT

Not Applicable.

### REFERENCE TO A “SEQUENCE LISTING,” A TABLE, OR A COMPUTER PROGRAM

Not Applicable.

### SUMMARY OF THE INVENTION

This invention relates to home construction, and in particular marking the location of a utility. It comprises a method and apparatus for permanently marking the location of one or more utilities of a building. The steps of the method comprise: attaching a stencil marker with at least one indentation along the width and at least one indicator, wherein the stencil marker is folded at the indention to form a ledge; positioning the stencil marker on a slab form so that the ledge rests on top of the form and on the side of the form that contacts the slab and so that the location of the indicator corresponds to the location of a utility of a building; pouring the slab within the form; removing the form and the stencil marker so that the shape of said indicator is permanently indented in the slab.

### DESCRIPTION OF THE DRAWINGS

The drawings constitute a part of this specification and include exemplary embodiments of the Utility Service Marker, which may be embodied in various forms. It is to be understood that in some instances, various aspects of the invention may be shown exaggerated or enlarged to facilitate an understanding of the invention. Therefore, the drawings may not be to scale.

FIG. 1 shows one embodiment of the apparatus that has three indicators and two indentions.

FIG. 2 shows one embodiment of the method and marker wherein the marker is attached to a form.

FIG. 3 shows one embodiment of the method and marker in a no-brick application.

FIG. 4 shows multiple embodiments of the apparatus with various indicators.

### BACKGROUND

Every home and most all industrial and commercial buildings have some kind of underground utility. Utilities include services provided by a public utility company, e.g., electricity, natural gas, water, sewer, and cable/phone lines. In order to protect the utility lines, they are often buried. Thus, once installed, it's impossible to know the location of the connection points to the public utility from the surface. This can pose issues in the event maintenance or upgrades are desired.

Some home and building owners may desire to mark the connection points (in and out) of the home or other building using physical markers. Prior art markers are often small, raised solid objects that are inserted in the ground overtop of the connection points.

However, the greatest downfall of these markers is that over time, they can be destroyed by everyday activities such as mowing or landscape work and/or obscured by landscaping or sediment buildup. This is especially an issue when ownership of a home or other building is transferred. It is incumbent on the new owner to locate the utility connection points even though they were not around when the house or other building was constructed.

Moreover, utility locating service typically only mark the public utilities. Other lines such as landscape irrigation, septic systems, and other gas or wiring added (e.g., yard lighting wiring, gas line to grills fire pits, etc.) will not be marked by a utility locating service. If these are installed when the house or other building is constructed, they may or may not be marked by typical underground utility marking means.

This invention addresses all of the issues presented by the prior art. The method and apparatus provide for a permanent marking system that cannot be destroyed or removed once set. This allows subsequent owners of a home or other building to locate the utility connection points, no matter the age of the building. Moreover, the flexibility in the design of this invention allows owners to mark other utility connections besides public utilities.

Claimed herein is a method and apparatus for marking the location of utilities connection by applying a stencil marker to slab during construction. The stencil marker is removably or permanently attached to the form of the slab during construction and removed when the form is removed. The indention of the stencil marker indicators is left in the slab as a permanent marker for utilities.

The inventive method and apparatus may be used in brick and non-brick applications.

It may be adapted to various sizes and indicators based on application. The method and apparatus are low cost and easy to install and use.

### DETAILED DESCRIPTION

The subject matter of the present invention is described with specificity herein to meet statutory requirements. However, the description itself is not intended to necessarily limit the scope of claims. Rather, the claimed subject matter might be embodied in other ways to include different steps or combinations of steps similar to the ones described in this document, in conjunction with other present or future technologies.

Described and claimed herein is a permanent utility marking system and apparatus for same that allows the user to identify the location of underground utility connection points of a home or other building. The system may be used in a brick and non-brick application.

The method uses a stencil marker comprising a lightweight material capable of being folded without failure. The stencil marker has at least one indicator that will imprint into the concrete slab once poured and cured. The location of the fold of the stencil marker is so that the at least one indicator hangs down from the form and to the concrete.

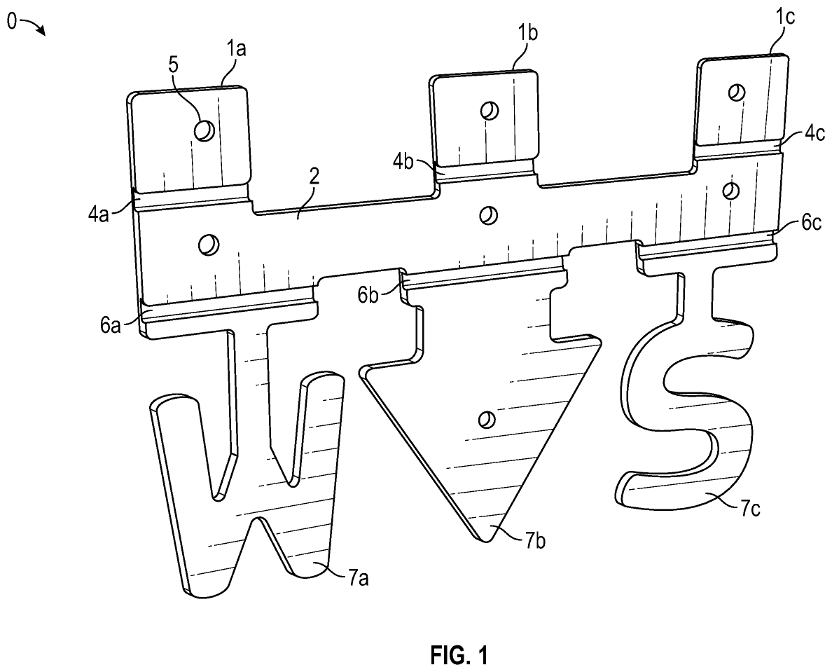

FIG. 1 depicts the invention embodied as one possible stencil marker for use in the method. The stencil marker 0 may be made of any suitable material. Preferably, the stencil marker is made from a suitably firm, but pliant material so that it may be folded by hand but not tear, rip, or otherwise come apart. Preferably, the stencil marker is made of a light weight and low-cost material. In one embodiment, the stencil marker 0 is made of polyethylene foam. In other embodiments, it is made of polyurethane foam. In other embodiments it is made of a blend of foams. However, any suitable material may be used.

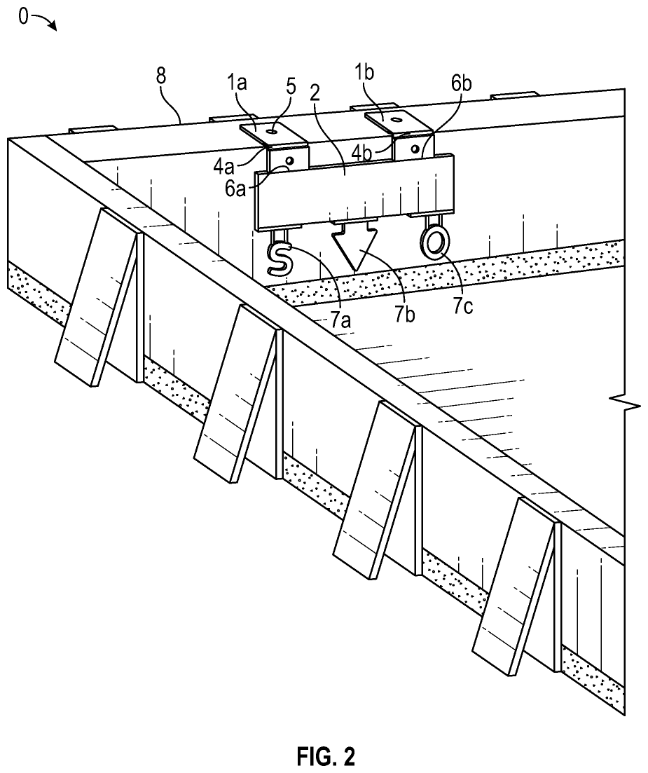

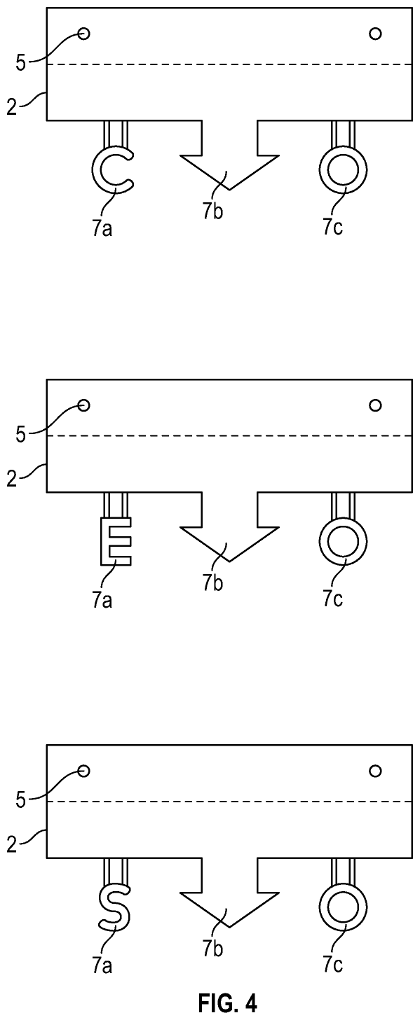

As shown, the stencil marker 0 comprises at least one, but preferably multiple indicators 7a, b, c. The indicators are formed in letters or shapes to indicate which utility is being located. The indicators 7a, b, c, are shaped in any suitable manner For example, as shown in FIG. 4, the indicators 7a, b, c, may be “C”, an arrow, and “O” so that the clean out may be labeled; “E”, an arrow, and “O” so that the electric out may be labeled; or “S”, an arrow, and “O” so that the sewer out may be labeled. As shown in FIGS. 1 and 2, “W”, an arrow, and “S” are used to label the water service. These are illustrative of the shapes that may be used.

In one or more embodiments, it may be desirable to use more than three indicators. In other embodiments, it may be desirable to use less than three indicators. For instance, perhaps there is a special gas line connected to the main gas line to power an outdoor kitchen, in that instance, the indicators may be “G”, “O”, “K”, and an arrow. In other embodiments still, it may be desirable to place more than one stencil marker 0 near each other along the slab.

A suitable size for the indicators 7a, b, c, is approximately two- and one-half inches to four inches in length and width. It may be desirable for the arrow indicator 7b to be longer than the other indicators 7a, 7c. Other sizes for the indicators may be used to fit the application.

The arrow or pointer may be of any suitable shape to indicate the location of the particular service or utility line.

The base 2 is also shown in FIG. 1. The base provides for extra length between the indicators 7a, b, c, and the top of the concrete slab. An elongated base 2 is especially helpful in brick applications as shown in FIG. 2. In this embodiment, the base allows the indicators 7a, b, c, to be imprinted approximately three- and one-half inches from the top of the slab. The base height as shown in the depicted embodiment is between one and one half and three inches. However, other lengths may be used depending on the application.

A suitable length for the base 2 is approximately ten inches. However, it may be longer or shorter depending on the indicators used and the application.

As depicted in FIG. 1, the stencil marker 0 comprises a plurality of indentations 4a, b, c, 6a, b, c. These indentions allow a user to fold the stencil marker 0 in order to attach it to a form 8 for use. For example, in a brick application the indentions 4a, b, c, are located such that the stencil marker 0 may be folded at the bottom of tabs 1a, b, c so that a ledge is created (see FIG. 2). The ledge may then sit on top of a flat surface. In other embodiments, the indention may span the entire length of the base 2.

The embodiment in FIG. 1 also includes indentions 6a, b, c, at the top of the stem of the indicators 7a, b, c. This allows the stencil marker 0 to be used in non-brick applications as well, and/or to allow the user to control the location of the indicators 7a, b, c, with respect the top of the slab.

The stencil marker 0 may also comprise a plurality of holes, e.g., 5. The holes 5 allow the user to removably or permanently connect the stencil marker 0 to a wooden form 8. Wooden forms in home building are none in the art and depicted in FIG. 2.

Preferably, nails are passed through one or more holes 5. The stencil marker 0 may have more or less holes than depicted, as long as the stencil marker 0 remains stationary and in the desired location when the slab is poured. As depicted, the holes are between one half and one inch in from the edge of the stencil marker 0. However, any suitable placement is contemplated.

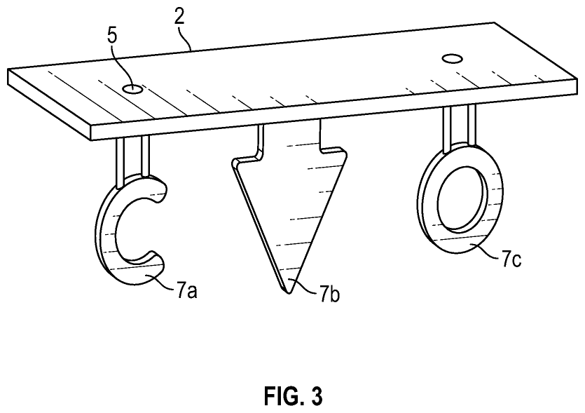

FIG. 3 shows another embodiment of the no-brick application. As depicted, the stencil marker 0 does not comprise tabs 1a, b, c. Rather, the indicators 7a, b, c, are connected directly to the base 2. In this embodiment, the stencil marker 0 folds at the connection between the stem of the indicators 7a, b, c, and the base 2.

The stencil marker 0 is used as part of the inventive method. In one embodiment, the method comprises folding the stencil marker at the indentions in the tabs 4a, b, c to form a ledge. The ledge is then placed on the top of the form 8 as shown in FIG. 2. The ledge is placed so that the indicators 7a, b, c will contact the concrete slab when poured into the frame.

The ledge is also placed so as to allow the indicators 7a, b, c, to correspond to the location of the utility. In the depicted embodiment, the ledge is placed so that the arrow 7b points to the location in the ground of the utility.

In other embodiments, the stencil marker is folded at 6a, b, c to form a longer/larger ledge and a shorter distance between the top of the form 8 and the indicators 7a, b, c.

Once the stencil marker is in place, the slab is poured and once cured, the form 8 and the stencil marker 0 are removed. This leaves behind the indentation of the indicators 7a, b, c, in the cured slab.

For the purpose of understanding the Utility Service Marker, references are made in the text to exemplary embodiments of the Utility Service Marker, only some of which are described herein. It should be understood that no limitations on the scope of the invention are intended by describing these exemplary embodiments. One of ordinary skill in the art will readily appreciate that alternate but functionally equivalent components, materials, designs, and equipment may be used. The inclusion of additional elements may be deemed readily apparent and obvious to one of ordinary skill in the art. Specific elements disclosed herein are not to be interpreted as limiting, but rather as a basis for the claims and as a representative basis for teaching one of ordinary skill in the art to employ the present invention.

1. A method for permanently marking the location of one or more utilities of a building comprising:
a. attaching a stencil marker comprising at least one indentation along the width of said stencil marker, and at least one indicator, wherein said stencil marker is folded at said at least one indention to form a ledge;
b. positioning said stencil marker on a form so that said ledge rests on top of said form and on the side of said form that contacts the slab and so that the location of said at least one indicator corresponds to the location of a utility of said building;
c. pouring the slab within said form;
d. removing said form and said stencil marker so that the shape of said indicator is permanently indented in the slab.

2. The method of claim 1 wherein said stencil marker further comprises a plurality of nail holes so that said positioning step further comprises driving a nail through each said plurality of nail holes and at least partially through said form to secure said stencil marker to said form.

3. The method of claim 1 wherein said stencil marker comprises at least two indicators and wherein the shape of at least one of said at least two indicators is pointed.

4. The method of claim 1 wherein said stencil marker further comprises at least two indentions parallel to each other.

5. The method of claim 1 wherein said stencil marker further comprises at least one tab so that said indention is located at the base of said tab so that in said attaching step when said stencil marker is folded, said tab is perpendicular to the top of said form and forms said ledge.

6. An apparatus for permanently marking the location of one or more utilities of a building comprising:
a. a base comprising at least one indention that horizontally traverses the base at least partially so that said base may be folded at said indention; and
b. at least one indicator attached to said base, wherein when said base is folded at said indention, said at least one indicator is substantially perpendicular to the part of said base that is folded over.

7. The apparatus of claim 6 wherein said base further comprises at least one tab.

8. The apparatus of claim 6 wherein said base further comprises a plurality of nail holes.

9. The apparatus of claim 6 comprising at least two indicators, wherein at least one of said at least two indicators is shaped like an arrow or triangle.

10. A method for permanently marking the location of one or more utilities of a building comprising:
a. placing a stencil marker with at least one indicator and at least one ledge on the form so that said ledge rests on top of the form and on the inside of the form so that said at least one indicator contacts the slab when poured, and wherein said form is positioned to correspond with the location of at least one utility of said building;
b. pouring the slab within said form and allowing the slab to cure; and
c. removing the form and said stencil marker.
